(19) United States
(12) Patent Application Publication
(10) Pub. No.: US 2010/0259639 A1
(43) Pub. Date: Oct. 14, 2010

(54) AUTOMATIC BACKLIGHT DETECTION

(75) Inventors: Szepo R. Hung, Carlsbad, CA (US); Ruben M. Velarde, Chula Vista, CA (US); Liang Liang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/422,850

(22) Filed: Apr. 13, 2009

(51) Int. Cl. H04N 9/73; G06K 9/40; G06K 9/46; G06K 9/00

(52) U.S. Cl. 348/223.1; 382/274; 382/195; 382/167; 348/E09.051

(57) ABSTRACT

In a particular embodiment, a method is disclosed that includes receiving image data at an auto white balance module and generating auto white balance data. The method further includes detecting a backlight condition based on the auto white balance data. An apparatus to automatically detect a backlight condition is also disclosed.

### FIELD OF THE DISCLOSURE

The present disclosure is generally directed to video and still image processing, and more particularly, to backlight detection affecting image generation.

### BACKGROUND

Lighting conditions affect the quality of digital images taken by still and video cameras. For instance, capturing an image of an object in the foreground under backlighting conditions can result in an object of interest appearing darker than the background. The details of the object on a captured image are consequently harder to view.

Backlighting results in the background of an image having a higher luminance than the object of interest. A backlight condition may occur in an indoor, outdoor, or mixed indoor and outdoor environment. Due to a bright background resulting from backlighting, the object of interest may be darker than desired.

Advances in digital photography have led to techniques that counteract backlighting. For example, advances in flash, backlight gamma, luma adaptation and increased exposure capabilities may function to brighten up the object of interest.

Despite these advances, some users fail to benefit from such backlighting compensation technologies. Users conventionally manually activate the backlighting compensation function. The manual nature of a switch or other activation sequence requires the user to know when it is appropriate to turn on the backlighting compensation function. The steps involved to activate such function may be inconvenient for some users. For example, a photographer may be reluctant to divert their attention away from the subject of their photograph in order to flip a backlight switch. Consequently, some users do not avail themselves of the backlighting compensation technology and are relegated to capturing images with reduced picture quality.

### SUMMARY

A particular embodiment automatically detects a backlighting condition using a combination of backlighting tests. A first test determines the presence of a backlight condition by evaluating whether histogram data generated from image data exceeds high and low frequency thresholds. A second test uses collected auto white balance statistics to identify indoor and outdoor regions of the image data. A comparison of the indoor and outdoor data is further used to determine the presence of a backlight condition. Where a third test detects a face in the image, an embodiment may provide facial backlight compensation.

In another particular embodiment, a method is disclosed that includes receiving image data at an auto white balance module and generating auto white balance data. The method further includes detecting a backlight condition based on the auto white balance data.

In another embodiment, an apparatus is disclosed that includes an auto white balance module configured to receive image data. The apparatus includes a backlight detection module. The backlight detection module is coupled to receive data from the auto white balance module and includes logic to determine whether a backlight condition exists based on an evaluation of the data from the auto white balance module.

In another embodiment, an apparatus is disclosed that includes means for automatically white balancing image data to generate white balance data, as well as means for detecting a backlight condition based on the white balance data.

In another embodiment, a computer readable medium storing computer executable code is disclosed. The computer readable medium includes code executable by a computer to automatically white balance image data to generate white balance data. The code executable by the computer may detect a backlight condition based on the white balance data.

Particular advantages provided by disclosed embodiments may include improved user convenience and image quality. Embodiments may include an intelligent and automatic backlight detection algorithm that runs continuously. When the automatic backlight detection algorithm detects a backlight condition, an apparatus may automatically apply backlight compensation without user intervention.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a block diagram of a particular illustrative embodiment of an automatic backlight detection apparatus;

FIG. 2 is a histogram that includes a frequency plot indicative of luminance and a threshold used to detect a backlighting condition by a histogram module of the apparatus of FIG. 1;

FIG. 3 is a graph illustrating a statistics collection process by an auto white balance module of the apparatus of FIG. 1 that depicts a rectangular box showing gray pixels in two dimensions of a color space to generate auto white balance data;

FIG. 4 is a graph showing a distribution of plotted reference and indoor sample points created using auto white balance data generated by the auto white balance module of FIG. 1;

FIG. 5 is a graph showing a distribution of plotted reference and outdoor sample points created using auto white balance data generated by the auto white balance module of FIG. 1;

FIG. 6 is a graph showing a distribution of reference points, along with both indoor and outdoor sample points, created using auto white balance data generated by the auto white balance module of FIG. 1;

FIG. 7 is a flowchart showing a particular embodiment of a method of automatically detecting a backlight condition as may be controlled by the apparatus of FIG. 1;

FIG. 8 is a flowchart showing another particular embodiment of a method of automatically detecting a backlight condition as may be controlled by the apparatus of FIG. 1;

FIG. 9 is a flowchart showing a particular embodiment of a method of identifying indoor and outdoor portions of an image as may be controlled by the apparatus of FIG. 1;

FIG. 10 is a flowchart showing a particular embodiment of a method of determining an average value of gray pixels within each of a plurality of areas as may be controlled by the apparatus of FIG. 1;

FIG. 11 is a block diagram of particular embodiment of an automatic backlight detection device configured to use auto white balance data to detect and compensate for a backlighting condition; and

FIG. 12 is a block diagram of another particular embodiment of an automatic backlight detection device configured to use auto white balance data to detect and compensate for a backlighting condition.

### DETAILED DESCRIPTION

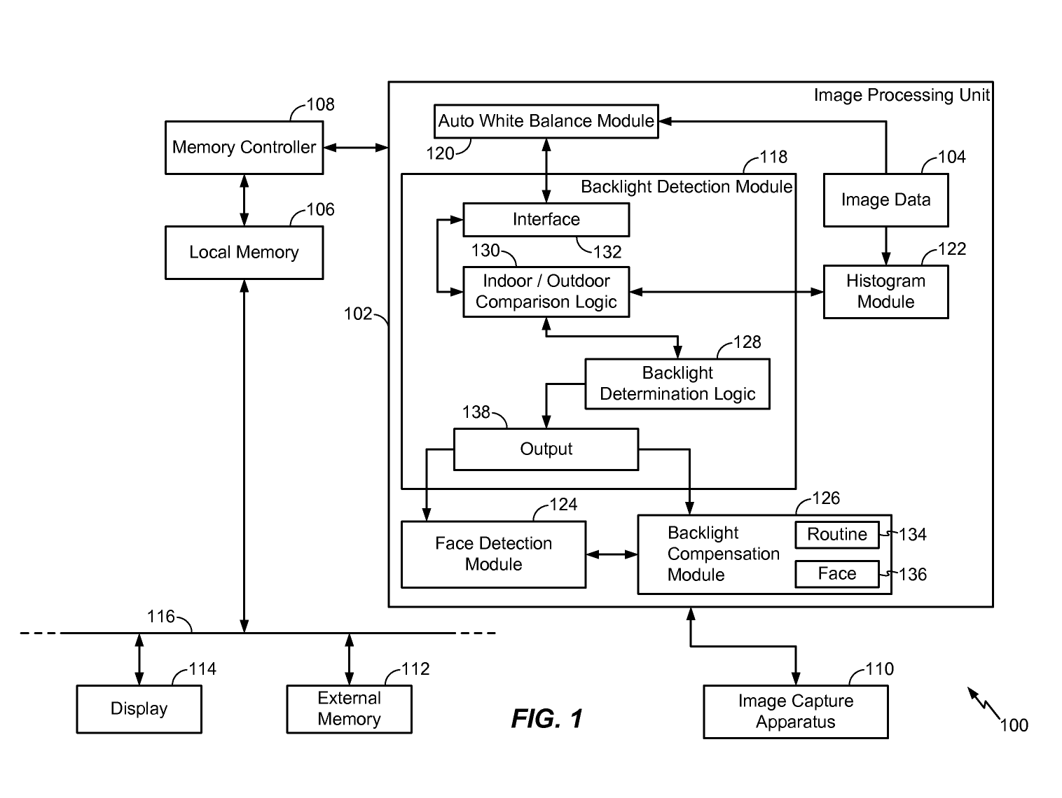

FIG. 1 is a block diagram illustrating an apparatus 100 that may automatically detect a backlight condition. The apparatus 100 may include an image processing unit 102 to store and perform various processing techniques on image data 104 in accordance with various embodiments. As described herein, the image processing unit 102 may generate and use auto white balance data to detect a backlight condition. Generally, the apparatus 100 may enhance digital imagery by providing automatic detection and the correction or compensation of the backlighting condition.

The image processing unit 102 may comprise a chipset that includes a digital signal processor (DSP), on-chip memory, and hardware logic or circuitry. More generally, the image processing unit 102 may comprise any combination of processors, hardware, software or firmware, and the various components of the image processing unit 102 may be implemented as such.

In the illustrated example of FIG. 1, the apparatus 100 also includes a local memory 106 and a memory controller 108. The local memory 106 may store raw image data. The local memory 106 may also store processed image data following processing that is performed by the image processing unit 102.

The memory controller 108 may control the memory organization within the local memory 106. The memory controller 108 may also control memory loads from the local memory 106 to the image processing unit 102. The memory controller 108 may also control write backs from the image processing unit 102 to the local memory 106. The images processed by the image processing unit 102 may be loaded directly into the local memory 106 from an image capture apparatus 110 following image capture or may be stored in the local memory 106 during image processing.

In the exemplary embodiment, the apparatus 100 includes the image capture apparatus 110 to capture images that are processed, although this disclosure is not limited in this respect. The image capture apparatus 110 may include arrays of solid state sensor elements, such as complementary metal-oxide semiconductor (CMOS) sensor elements, charge coupled device (CCD) sensor elements, or the like. Alternatively or additionally, the image capture apparatus 110 may include a set of image sensors that include color filter arrays (CFAs) arranged on a surface of the respective sensors. In either case, the image capture apparatus 110 may be coupled directly to the image processing unit 102 to avoid latency in the image processing. One skilled in the art should appreciate that other types of image sensors could also be used to capture image data 104. The image capture apparatus 110 may capture still images or full motion video sequences. In the latter case, image processing may be performed on one or more image frames of the video sequence.

The apparatus 100 may include a display 114 that displays an image following the image processing as described in this disclosure. After image processing, the image may be written to the local memory 106 or to an external memory 112. Processed images may be sent to the display 114 for presentation to a user.

In some cases, the apparatus 100 may include multiple memories. The external memory 112, for example, may include a relatively large memory space. The external memory 112 may comprise dynamic random access memory (DRAM). In other examples, the external memory 112 may include a non-volatile memory, such as FLASH memory, or any other type of data storage unit. The local memory 106 may comprise a relatively smaller and faster memory space. By way of example, the local memory 106 may comprise synchronous dynamic random access memory (SDRAM).

The local memory 106 and the external memory 112 are merely exemplary, and may be combined into the same memory component, or may be implemented in a number of other configurations. In a particular embodiment, the local memory 106 forms a part of the external memory 112, typically in SDRAM. In this case, both the local memory 106 and the external memory 112 may be external in the sense that neither memory may be located on-chip with the image processing unit 104. Alternatively, the local memory 106 may comprise on-chip memory buffers, while the external memory 112 may be external to the chip. The local memory 106, the display 114, and the external memory 112 (and other components if desired) may be coupled via a communication bus 116

The apparatus 100 may also include a transmitter (not shown) to transmit processed images or coded sequences of images to another device. The techniques of this disclosure may be used by handheld wireless communication devices (such as for cellular phones) that include digital camera functionality or digital video capabilities. In that case, the device may also include a modulator-demodulator (MODEM) to facilitate wireless modulation of baseband signals onto a carrier waveform in order facilitate wireless communication of the modulated information.

The image processing unit 102 of FIG. 1 may include a backlight detection module 118, an auto white balance module 120, a histogram module 122, a face detection module 124, and a backlight compensation module 126. As discussed below in greater detail, the backlight detection module 118 may employ multiple detection processes. The backlight detection module 118 may be coupled to receive data from the auto white balance module 120. The backlight detection module 118 may be configured to detect a backlight condition based upon an evaluation of the data from the auto white balance module 120. For example, the backlight detection module 118 may be configured to identify a first portion of an image as an indoor region and a second portion of the image as an outdoor region. The backlight detection module 118 may evaluate a brightness condition by comparing elements of the indoor region to a first threshold. The backlight detection module 118 may further compare elements of the outdoor region to a second threshold. A backlight determination may be made in response to the evaluated brightness conditions of the indoor and outdoor regions as compared to the first and second thresholds.

The backlight detection module 118 may include backlight determination logic 128, indoor/outdoor comparison logic 130, and an interface 132 for interfacing with the auto white balance module 120. The indoor/outdoor comparison logic 130 may process the output of the auto white balance module 120 to identify indoor and outdoor regions of received image data 104. The backlight determination logic 128 may be coupled to the indoor/outdoor comparison logic 130 and may be configured to determine a backlight condition. In this manner, the output 138 of the backlight determination logic 128 may be based in part on the auto white balance data generated by the auto white balance module 120.

The auto white balance module 120 may be configured to receive the image data 104 and to collect statistics. An embodiment of the auto white balance module 120 may further apply white balance gains according to the statistics. The auto white balance module 120 may output auto white balance data used by the backlight detection module 118 to evaluate backlighting.

Another testing unit used to detect backlighting includes the histogram module 122. The histogram module 122 may apply high and low threshold percentages to histogram data to determine the presence of a backlight condition. Where the histogram data exceeds both the high and low thresholds, the histogram module 122 may determine that a backlight condition is present. For example, a histogram may include a frequency graph indicative of the luminance in an image. A high threshold percentage and a low threshold percentage may be included in the histogram. The histogram module 122 may determine that some pixels are darker than the low threshold. The histogram may also indicate that there are some pixels brighter than the high threshold. When there are pixels that exceed both thresholds, the histogram module 122 may indicate that a backlight condition is detected.

Should both thresholds of the histogram not be exceeded, the histogram module 122 may alternatively indicate that no backlight condition is detected. For example, if there are pixels brighter than the high threshold, but there are no pixels darker than the low threshold, the histogram module 122 may determine that no backlight condition is present. The same result may be determined where neither the high nor the low threshold is exceeded.

Embodiments may use the histogram module 122 to evaluate histogram data. Histogram data may be processed to detect a backlighting condition. For instance, a histogram that includes peaks at each end may indicate a severe backlight condition. Another histogram with a peak in the high end of the histogram and that increases in the dark region may indicate a moderate backlight condition. Still another histogram with one peak in the high end may correspond to a slight backlight condition.

The histogram module 122 may use such histogram data to perform a first backlight test on the image data 104. For example, the histogram module 122 may determine whether a number of pixels having a brightness value less than a first value exceed a first threshold. The histogram module 122 may also determine whether a number of pixels having a brightness value greater than a second value exceed a second threshold.

The face detection module 124 may adjust the backlight compensation to bring detected faces to a proper brightness level. Where no face is present in the image data, regular backlight compensation may be applied. The face detection module 124 may comprise an auxiliary testing process in some embodiments.

The backlight compensation unit 126 may include processes for counteracting backlight phenomena, including face priority backlight compensation techniques. Flash, backlight gamma, luma adaptation, and increased exposure techniques, among others, may be used to brighten up a relatively darker object of interest.

The image data 104 may arrive at the image processing unit 102. As shown in the embodiment of FIG. 1, the histogram module 122 may be used to detect a backlight condition based on histogram data generated from the image data 104. The image data 104 may concurrently arrive at the auto white balance module 120. The auto white balance module 120 may collect auto white balance data that is evaluated by the backlight detection module 118 to determine if a backlight condition is likely. The output of the histogram module 122 and the auto white balance module 120 may be conjunctively processed to determine whether a backlight condition exists. For example, the backlight detection module 118 may detect a backlight condition after determining that the respective outputs of both the histogram module 122 and the auto white balance module 120 indicate a likelihood of a backlight condition.

Where no backlight condition is detected, the image data 104 may be processed by a routine backlight compensation process 134 of the backlight compensation module 126. The image data 104 may also be processed by the face detection module 124. The face detection module 124 may determine if any faces are included in the image data 104. Depending upon the determination of the face detection module 124, the image data 104 may be passed to a face priority backlight compensation process 136 of the backlight compensation module 126, in addition or in the alternative to the routine backlight compensation program 128.

The apparatus 100 may form part of an image capture device or a digital video device capable of coding and transmitting and/or receiving video sequences. By way of example, apparatus 100 may comprise a stand-alone digital camera or video camcorder, a wireless communication device such as a cellular or satellite radio telephone, a personal digital assistant (PDA), a computer, or any device with imaging or video capabilities in which image processing is desirable.

A number of other elements may also be included in the apparatus 100, but are not specifically illustrated in FIG. 1 for simplicity and ease of illustration. The architecture illustrated in FIG. 1 is merely exemplary, as the techniques described herein may be implemented with a variety of other architectures.

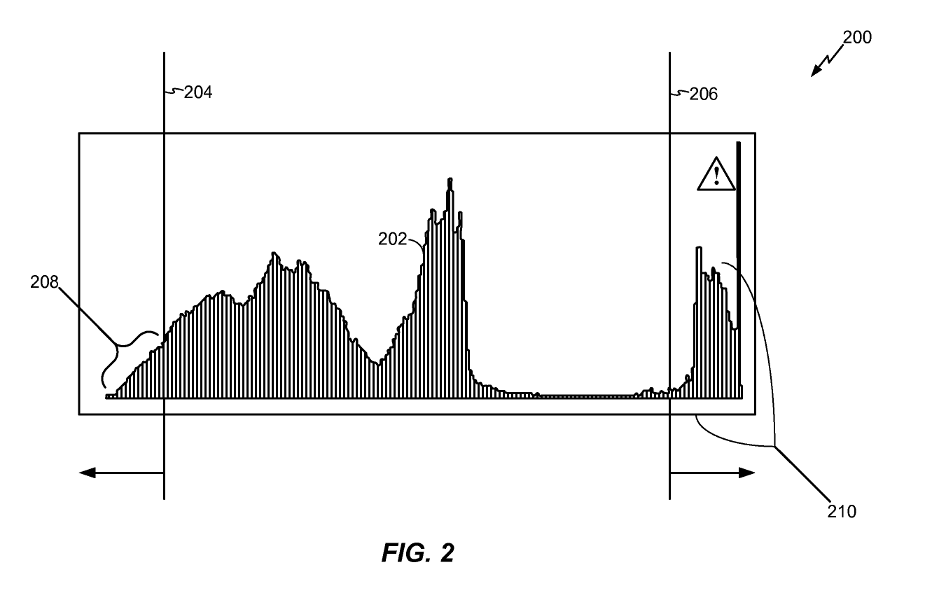

FIG. 2 shows an exemplary histogram 200 that may be generated and processed by the histogram module 122 of FIG. 1. The data of the histogram 200 may be automatically evaluated to detect a backlighting condition. As shown in the embodiment of FIG. 2, the histogram 200 includes a frequency plot 202 indicative of luminance. A line comprising a low threshold 204 and a line comprising a high threshold 206 may be included in the histogram 200. As shown in FIG. 2, the exemplary histogram 200 includes some pixels 208 that are darker than the low threshold 204. The histogram 200 also indicates that there are some pixels 210 that are brighter than the high threshold 206. Where there are pixels 208, 210 that respectively exceed both thresholds 204, 206 as shown, the histogram module 122 may determine that a backlight condition is detected or likely.

Should the pixel data of the histogram not exceed both thresholds 204, 206, the histogram module 122 may output that no backlight condition is detected. For example, a histogram may include pixels that are darker than the low threshold, but may have no pixels brighter than the high threshold. In such an example, the histogram module 122 may determine that no backlight condition is detected.

The histogram detection technique illustrated in FIG. 2 may be advantageous for detecting many backlight scenes. However, pixels darker than the low threshold 204 may represent objects in the image data 104 that are actually very dark and that may not be the object of interest. Additional backlight tests may be used to confirm or initiate backlight determination of the histogram module 122.

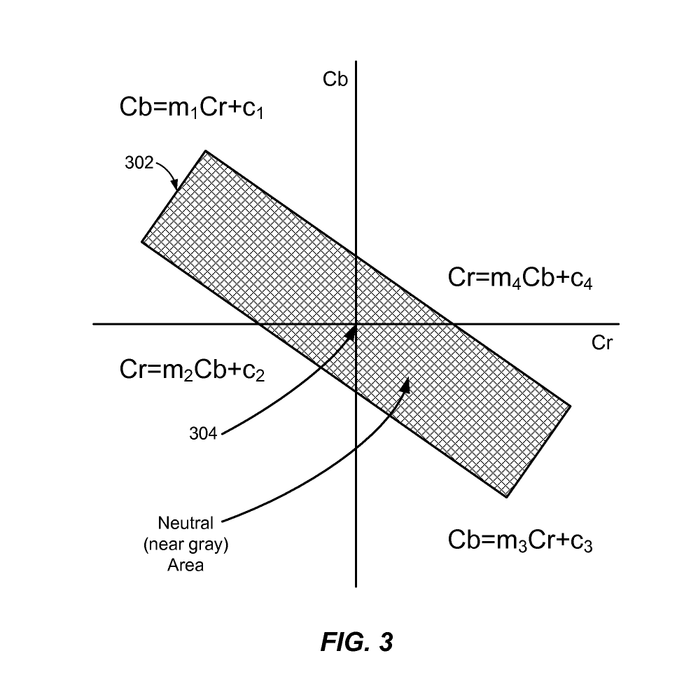

One such additional backlight test may be performed by the auto white balance module 120 of FIG. 1. The auto white balance module 120 may process received image data 104 to collect statistics including auto white balance data. The auto white balance data may be used to compare indoor and outdoor samples for detecting a backlighting condition. FIG. 3 graphically shows a method used by the auto white balance module 120 to collect statistics and otherwise generate the auto white balance data used in the indoor/outdoor comparisons.

FIG. 3 particularly shows a graph 300 illustrating a statistics collection method that uses a rectangular box 302 that includes gray pixels in two dimensions (Cr and Cb) of a YCrCb color space centered on a gray point 304. FIG. 3 graphically shows how the auto white balance module 120 of FIG. 1 may filter received image data 104 to generate the auto white balance data. In one configuration, the white balance module 120 of FIG. 1 may filter the captured image to select gray regions included within a predetermined luminance range. The white balance module 120 may then select those remaining regions that satisfy predetermined Cr and Cb criteria. The filtering processes of the auto white balance module 120 may use the luminance value to remove regions that are too dark or too bright. These regions may be excluded due to noise and saturation issues. The auto white balance module 120 may express the associated filter function as a number of equations. The regions that satisfy the set of inequalities (equations) may be considered as possible gray regions.

The auto white balance module 120 may provide a sum of Y, a sum of Cb, a sum of Cr and a number of pixels for each region. The image may be divided into N×N regions. Statistics collection may be set up using the following equations:

Y<=Ymax (1)

Y>=Ymin (2)

Cb<=m1*Cr+c1 (3)

Cr>=m2*Cb+c2 (4)

Cb>=m3*Cr+c3 (5)

Cr<=m4*Cb+c4 (6)

The values m1-m4 and c1-c4 may represent predetermined constants. These constants may be selected so that the filtered objects accurately represent gray regions while maintaining a sufficiently large range of filtered objects and an illuminant to be estimated for captured images. Other equations may be used with other embodiments.

An image may be divided to contain L×M rectangular regions, where L and M are positive integers. In this example, N=L×M may represent the total number of regions in an image. In one configuration, the auto white balance module 120 may divide the captured image into regions of 8×8 or 16×16 pixels. The auto white balance module 120 may transform the pixels of the captured image, for example, from RGB components to YCrCb components.

The auto white balance module 120 may process the filtered pixels to generate statistics for each of the regions. For example, the auto white balance module 120 may determine a sum of the filtered or constrained Cb, a sum of the filtered or constrained Cr, a sum of the filtered or constrained Y, and a number of pixels selected according to the constraints for the sum of Y, Cb and Cr. From the region statistics, the auto white balance module 120 may determine each region's sum of Cb, Cr and Y divided by the number of selected pixels to produce an average of Cb (aveCb), Cr, (aveCr) and Y (aveY). The apparatus 100 may transform the statistics back to RGB components to determine an average of R, G, and B.

The auto white balance module 120 of FIG. 1 may transform the region statistics to a grid coordinate system to determine a relationship to reference illuminants formatted for a coordinate system. In one configuration, the auto white balance module 120 may convert and quantize the region statistics into one of N×N grids in an (R/G, B/G) coordinate system. The grid distance need not be partitioned linearly. For example, a coordinate grid may be formed from non-linear partitioned R/G and B/G axes. The auto white balance module 120 may discard pairs of (aveR/aveG, aveB/aveG) that are outside of a predefined range.

In one embodiment, the auto white balance module 120 may advantageously transform the region statistics into a two-dimensional coordinate system. However, the use of a two-dimensional coordinate system is not a limitation, and the apparatus 100 may be configured to use any number of dimensions in the coordinate system. For example, in another configuration, the apparatus 100 may use a three-dimensional coordinate system corresponding to R, G, and B values normalized to a predetermined constant. The auto white balance module 120 may be configured to provide locations of reference illuminants for comparison to plotted samples.

The apparatus 100 may be configured to store statistics for one or more reference illuminants. The statistics for the one or more reference illuminants may be determined during a calibration routine. For instance, such a calibration routine may measure the performance of various parts of a camera during a manufacturing process.

A characterization process may measure the R/G and B/G of a type of sensor under office light. The manufacturing process may measure each sensor and record how far the sensor is away from the characterized value. The characterization process may take place off-line for a given sensor module, such as for a lens or sensor of the image capture apparatus 110 of FIG. 1. For an outdoor lighting condition, a series of pictures of gray objects corresponding to various times of the day may be collected. The pictures may include images captured in direct sunlight during different times of the day, during cloudy lighting, outdoor in the shade, etc. The R/G and B/G ratios of the gray objects under these various lighting conditions may be recorded. For an indoor lighting condition, images of gray objects may be captured using warm fluorescent light, cold fluorescent light, incandescent light and the like, or some other illuminant. Each of the lighting conditions may be used as a reference point. The R/G and B/G ratios are recorded for indoor lighting conditions.

In another configuration, the reference illuminants may include A (incandescent, tungsten, etc.), F (florescent), and multiple daylight illuminants referred to as D30, D50, and D70. The (R/G, B/G) coordinates of the reference coordinates may be defined by illuminant colors that are calculated by integrating the sensor modules' spectrum response and the illuminants' power distributions.

After determining the scale of the R/G and B/G ratios, the reference points may be located on a grid coordinate. The scale may be determined such that the grid distance may be used to properly differentiate between different reference points. The auto white balance module 120 may generate the illuminant statistics using the same coordinate grid used to characterize the gray regions.

The apparatus 100 may be configured to determine the distance from each grid point received to each of the reference points. The apparatus 100 may compare the determined distances against a predetermined threshold. If the shortest distance to any reference point exceeds the predetermined threshold, the point may be considered as an outlier and may be excluded.

The data points may be processed such that outliers are removed and the distance to each of the reference points may be summed. The apparatus 100 may determine the minimum distance to the reference points, as well as the lighting condition corresponding to the reference point.

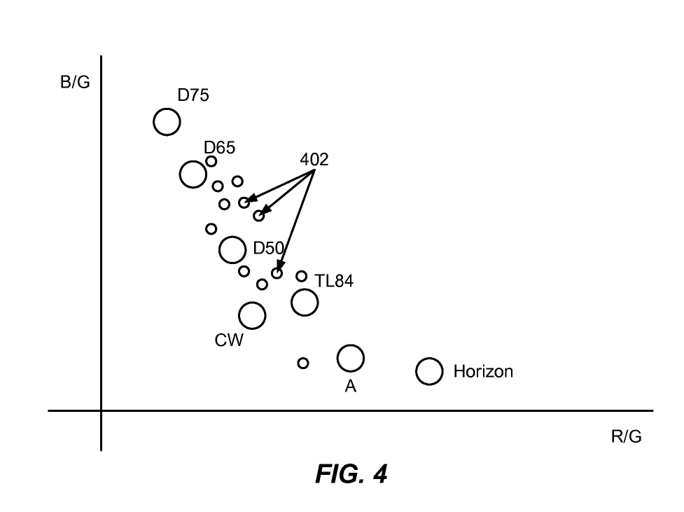

As discussed herein, an embodiment may receive image data 104 at the auto white balance module 120. Auto white balance data may be automatically generated using the filtering processes graphically illustrated in FIG. 3. For example, the auto white balance module 120 may generate auto white balance data by statistically analyzing the content or bias of red, green and blue pixels in a given scene. The auto white balance data may include brightness samples associated with the image data 104 and plotted near reference points that correspond to known color temperatures. Such a graph is shown in FIG. 4 and may be used to compare indoor and outdoor samples to detect backlighting conditions.

FIG. 4 particularly illustrates a graph 400 showing a distribution of reference points D75, D65, D50, CW, horizon, A, TL84. The graph 400 also includes smaller sample points 402 corresponding to collected image data samples plotted on a red/green (R/G) and blue/green (B/G) space. The reference points D75, D65, D50, CW, horizon, A, TL84 may correspond to pre-calibrated grey points.

While embodiments may include other reference points, exemplary lighting conditions (and associated color temperatures) represented in FIG. 4 may generally correspond to: a shady color space (D75), a cloudy color space (D65), a direct sun color space (D50), a cool white color space (CW), a typical office illumination color space (TL-84), an incandescent color space (A), and a horizon color space (horizon).

In the example of FIG. 4, the sample points 402 collected from the image data 104 by the auto white balance module 120 are plotted proximate to TL84 and CW. The TL 84 and CW reference points generally correspond to indoor color temperatures. The apparatus 100 may consequently determine from that proximity that the samples are indoor samples.

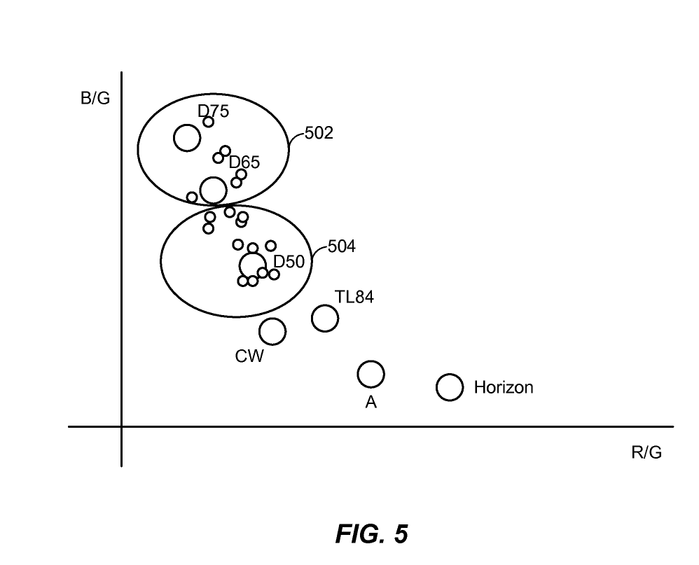

FIG. 5 shows plotted shady samples 502 near D75 and D65, with sunny samples 504 plotted near D50 by the auto white balance module 120. Such a distribution may suggest an outdoor backlight condition. Backlight may be detected where the samples in the high color temperature zone have both high luminance (e.g., likely to be sky and cloud) and low luminance samples (e.g., likely to be shadows). Additionally for the backlight condition to be detected, the number of low luminance samples in the high color temperature zone may exceed a certain threshold.

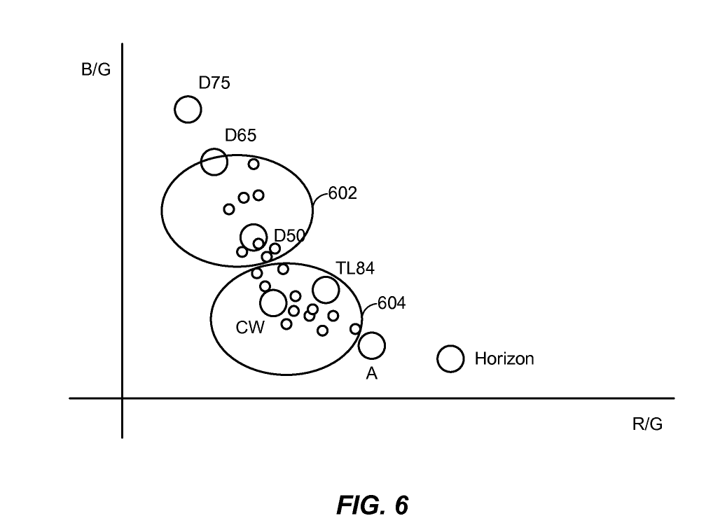

The example of FIG. 6 shows a graph 600 including both outdoor 602 and indoor samples 604. The outdoor samples are proximate D50, while the indoor samples 604 are near CW and TL84. This scenario may indicate a mixed indoor/outdoor backlight condition. A backlight condition may be detected where the outdoor samples 602 include significantly higher luminance values than the indoor samples 604. Another determining factor as to whether a backlight condition is detected may include whether the number of indoor samples 604 exceeds a certain threshold.

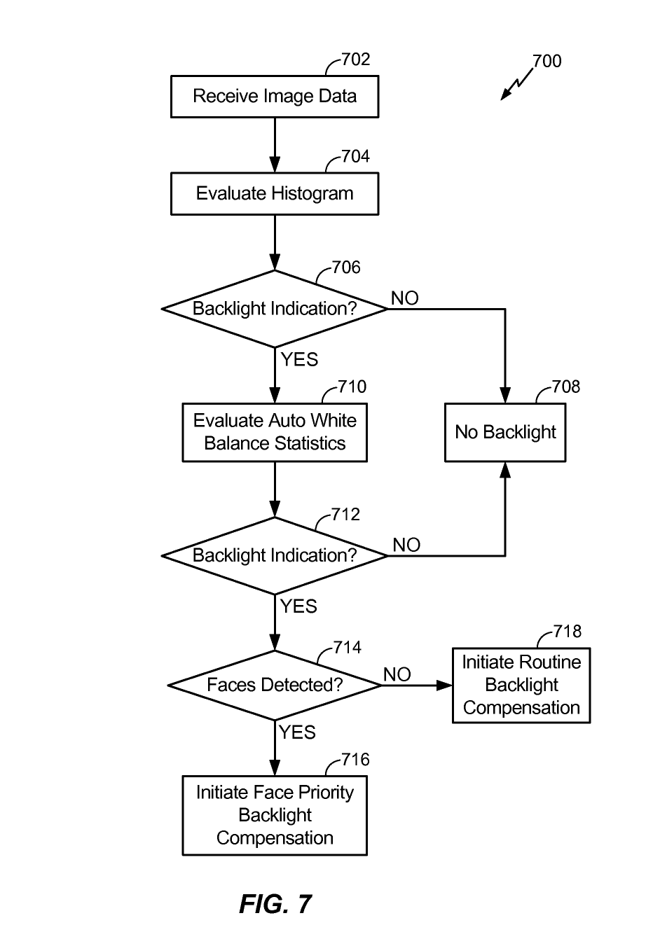

FIG. 7 shows a method 700 of automatically detecting a backlight condition as may be executed by the apparatus 100 of FIG. 1. In a particular embodiment, image data 104 may be received, at 702. For example, the histogram module 122 may receive image data 104 from a captured image.

At 704, a histogram may be evaluated. For example, histogram data associated with the image data 104 may be evaluated by the histogram module 122. Where a backlight condition is not indicated from the evaluation, at 706, the apparatus 100 may determine that a backlight condition does not exist, at 710.

Where a potential backlight condition is determined at 706, the auto white balance statistics may be evaluated at 710. The auto white balance module 120 may collect statistics and generate pixels samples from the image data that may be compared to stored reference values. The comparison may be controlled by the backlight detection module 118 and may determine if the pixel samples include indoor or outdoor color temperatures.

In a particular embodiment, a backlight condition may be detected where at least some outdoor samples in a high color temperature zone (e.g. above about 5500 Kelvin) include both high brightness samples and low brightness samples, and a number of low brightness samples in the high color temperature zone exceeds a fourth threshold that includes a stored value. In another particular embodiment, a backlight condition may be detected where at least some outdoor samples of the image have substantially higher brightness values than at least some indoor samples of the image, and the number of indoor low brightness samples exceeds a fifth threshold including a stored value. Should a backlight condition not be indicated at 712, the absence of a backlight condition may be detected, at 708. The method may not apply backlight compensation when one of the first test and the second test fail at 760 or 712, respectively.

Processes may be initiated at 714 to determine the presence of a face in the image data 104 in response to an indication of a backlight condition at 712. Where a face is detected at 714, a face priority backlight compensation process, such as face priority backlight compensation process 136, may be initiated at block 716. In a particular embodiment, a face is identified within the outdoor region. An element of the face region may be compared with a third threshold to evaluate the brightness. An exemplary third threshold may include a stored facial luminance reference value. Where no faces are detected at block 714, a routine backlight compensation process, such as the routine backlight compensation process 134, may be initiated at 718.

FIG. 7 includes a method 700 executable by the apparatus 100 of FIG. 1 for automatically detecting and correcting backlight conditions. Embodiments described in reference to FIG. 7 may automatically detect and compensate backlight conditions to increase image quality, while providing increased convenience to users.

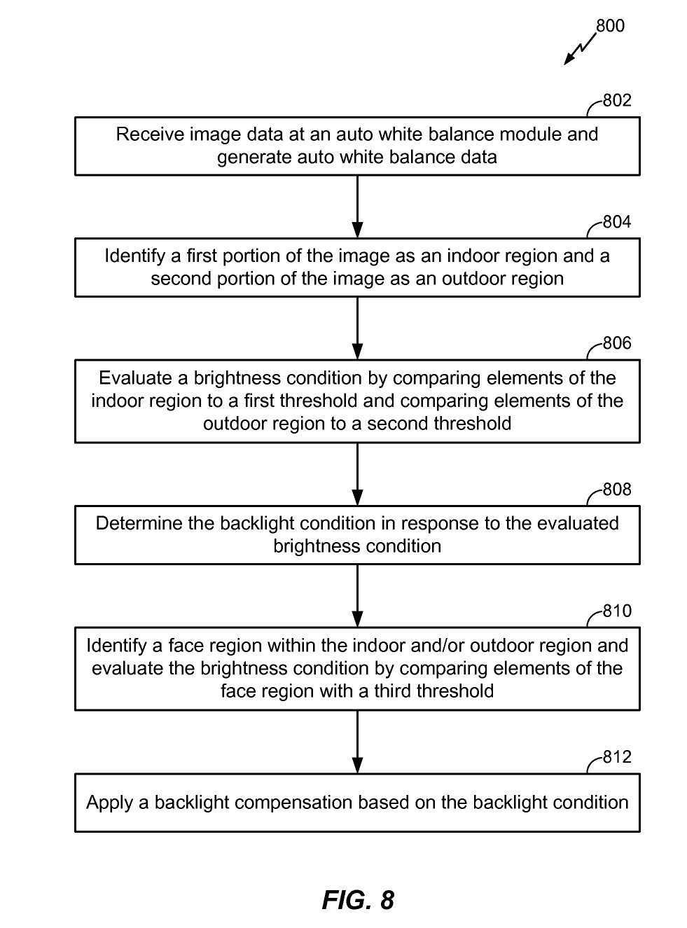

FIG. 8 shows a method 800 that includes receiving image data 104 at an auto white balance module and generating auto white balance data at 802. At 802, the method may include detecting a backlight condition based on the auto white balance data. The image data 104 may correspond to an image captured by an image capture device 110.

At 804, the method may identify a first portion of the image as an indoor region and a second portion of the image as an outdoor region. The method evaluates a brightness condition by comparing elements of the indoor region to a first threshold and comparing elements of the outdoor region to a second threshold, at 806. A backlight condition may be determined at 808 in response to the evaluated brightness condition. In one embodiment, the method may be controlled in part by the backlight detection module 118. The backlight detection module 118 may receive the auto white balance data.

In a particular embodiment, the method identifies a face region within the indoor region of the image, at 810. Evaluating the brightness condition may further include comparing elements of the face region with a third threshold. The method may also identify a face region within the outdoor region and compare elements of the face region with a third threshold. The method at may apply backlight compensation based on the backlight condition, at 812.

FIG. 8 includes a method executable by the apparatus 100 of FIG. 1 for automatically detecting and correcting backlight conditions. Embodiments described in reference to FIG. 8 may automatically detect and compensate backlight conditions to increase image quality, while providing increased convenience to users.

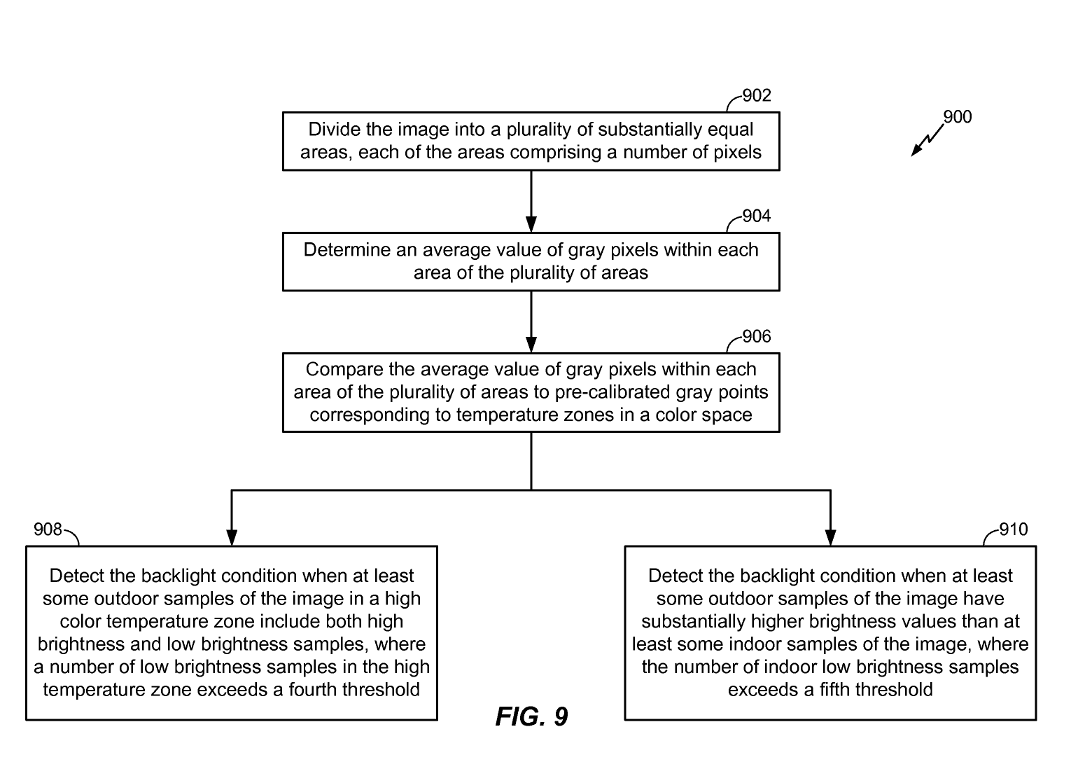

FIG. 9 shows a method 900 for identifying the first and second, e.g., indoor and outdoor, portions of a captured image. At 902, an embodiment of the method divides the image into a plurality of substantially equal areas, where each of the areas comprises a number of pixels. An average value of gray pixels within each of the plurality of areas may be determined, at 904. The average value of gray pixels within each area of the plurality of areas may be compared to pre-calibrated gray points corresponding to temperature zones in a color space, at 906.

According a particular embodiment, the backlight condition is detected when at least some outdoor samples of the image in a high color temperature zone include both high brightness samples and low brightness samples, and where a number of low brightness samples in the high temperature zone exceeds a fourth threshold at 908. At 910, the method detects the backlight condition when at least some outdoor samples of the image have substantially higher brightness values than at least some indoor samples of the image and where the number of indoor low brightness samples exceeds a fifth threshold.

FIG. 9 includes a method executable by the indoor/outdoor comparison logic 130 of FIG. 1 for automatically detecting a backlight condition. Embodiments described in reference to FIG. 9 may automatically detect backlight conditions based on a plotted distribution of brightness samples. By identifying and evaluating indoor and outdoor brightness samples, the method may increase image quality and user convenience.

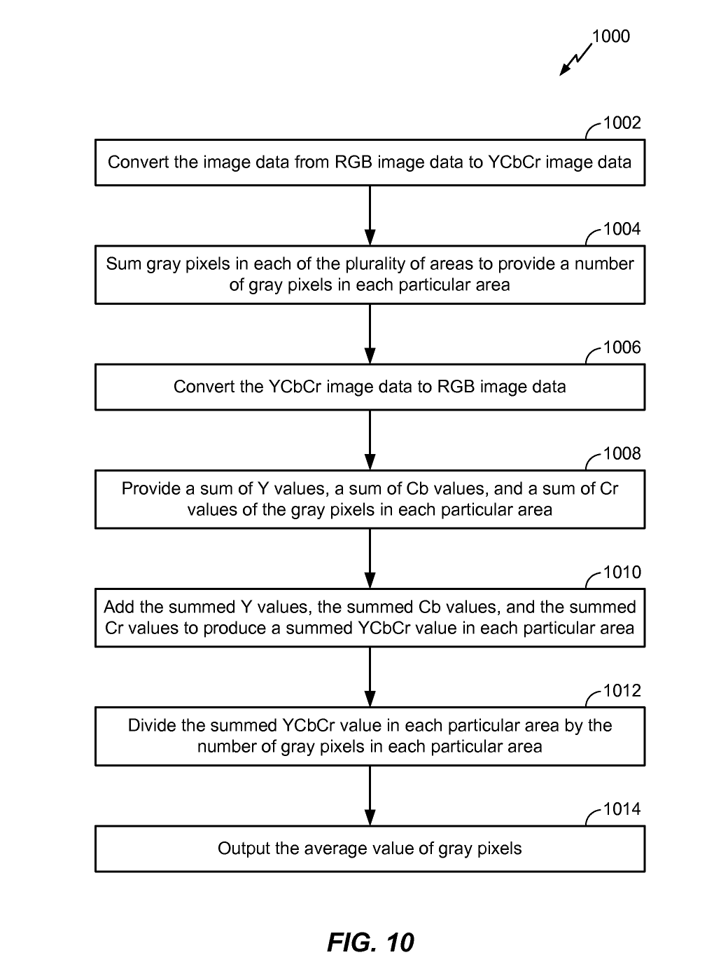

FIG. 10 shows a method 1000 for determining an average value of gray pixels within each of a plurality of areas of an image. At 1002, a particular embodiment converts the image data 104 from RGB image data to YCbCr image data. At 1004, the gray pixels in each of the plurality of areas may be summed to provide a number of gray pixels in each particular area. The method may convert the YCbCr image data to RGB image data at 1006. At 1008, the method may provide a sum of luminance (Y) values, a sum of chroma blue (Cb) values, and a sum of chroma red (Cr) values of the gray pixels in each particular area. The summed Y values, the summed Cb values, and the summed Cr values may be added to produce a summed YCbCr value in each particular area at 1010. The method may divide the summed YCbCr value in each particular area by the number of gray pixels in each particular area, at 1012. At 1014, the average value of the gray pixels within each of the plurality of areas may be output.

FIG. 10 includes a method executable by the auto white balance module 120 of FIG. 1 for generating auto white balance statistics, e.g., gray pixel within areas of an image, that may be used in identifying indoor and outdoor brightness samples. The statistics and identification may facilitate the automatic detection and correction of backlight conditions. The method described in FIG. 10 may promote increased image quality and user convenience.

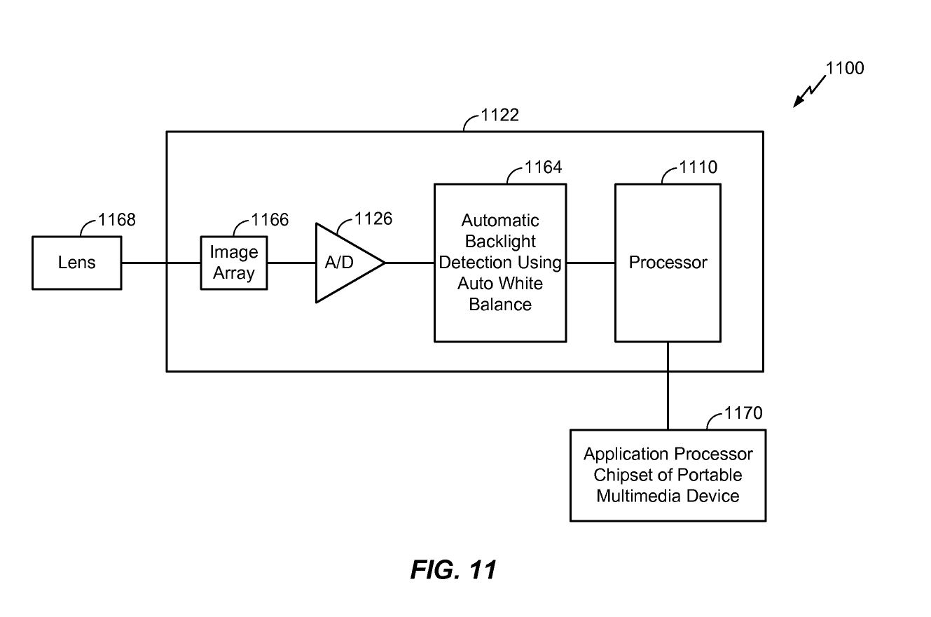

Referring to FIG. 11, a block diagram of a particular illustrative embodiment of an apparatus configured to automatically detect a backlight condition using auto white balance data is depicted and generally designated 1100. The apparatus 1100 includes an image sensor device 1122 that is coupled to a lens 1168 and that is also coupled to an application processor chipset of a portable multimedia device 1170. The image sensor device 1122 includes an automatic backlight detection module 1164 that uses auto white balance data to detect backlighting conditions.

The automatic backlight detection module 1164 is coupled to receive image data from an image array 1166, such as via an analog-to-digital convertor 1126 that is coupled to receive an output of the image array 1166 and to provide the image data to the automatic backlight detection module 1164.

The image sensor device 1122 may also include a processor 1110. In a particular embodiment, the processor 1110 is configured to implement backlighting detection using auto white balance data. In another embodiment, the automatic backlight detection module 1164 is implemented as separate image processing circuitry.

The processor 1110 may also be configured to perform additional image processing operations, such as one or more of the operations performed by the modules 120, 122, 124, 132 of FIG. 1. The processor 1110 may provide processed image data to the application processor chipset 1170 for further processing, transmission, storage, display, or any combination thereof.

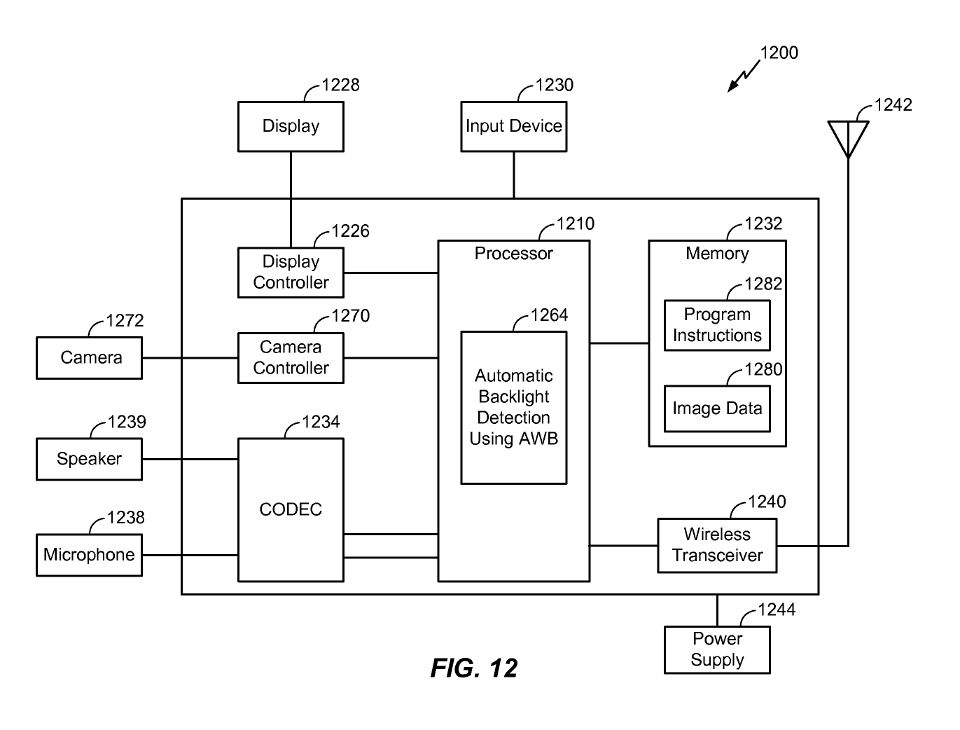

FIG. 12 is a block diagram of particular embodiment of an apparatus 1200 including an automatic backlighting detection module 1264 configured to use auto white balance data to detect backlighting. The apparatus 1200 may be implemented in a portable electronic device and includes a processor 1210, such as a digital signal processor (DSP), coupled to a memory 1232.

A camera interface controller 1270 is coupled to the processor 1210 and is also coupled to a camera 1272, such as a video camera. The camera controller 1270 may be responsive to the processor 1210, such as for autofocusing and autoexposure control. A display controller 1226 is coupled to the processor 1210 and to a display device 1228. A coder/decoder (CODEC) 1234 can also be coupled to the processor 1210. A speaker 1236 and a microphone 1238 can be coupled to the CODEC 1234. A wireless interface 1240 can be coupled to the processor 1210 and to a wireless antenna 1242.

The processor 1210 may also be adapted to generate processed image data 1280. The display controller 1226 is configured to receive the processed image data 1280 and to provide the processed image data 1280 to the display device 1228. In addition, the memory 1232 may be configured to receive and to store the processed image data 1280, and the wireless interface 1240 may be configured to retrieve the processed image data 1280 for transmission via the antenna 1242.

In a particular embodiment, the automatic backlighting detection module 1264 is implemented as computer code that is executable at the processor 1210, such as computer executable instructions that are stored at a computer readable medium. For example, the program instructions 1282 may include code to automatically white balance image data 1280 to generate white balance data and to detect a backlight condition based on the white balance data.

In a particular embodiment, the processor 1210, the display controller 1226, the memory 1232, the CODEC 1234, the wireless interface 1240, and the camera controller 1270 are included in a system-in-package or system-on-chip device 1222. In a particular embodiment, an input device 1230 and a power supply 1244 are coupled to the system-on-chip device 1222. Moreover, in a particular embodiment, as illustrated in FIG. 12, the display device 1228, the input device 1230, the speaker 1236, the microphone 1238, the wireless antenna 1242, the video camera 1272, and the power supply 1244 are external to the system-on-chip device 1222. However, each of the display device 1228, the input device 1230, the speaker 1236, the microphone 1238, the wireless antenna 1242, the camera 1272, and the power supply 1244 can be coupled to a component of the system-on-chip device 1222, such as an interface or a controller.

A number of image processing techniques have been described. The techniques may be implemented in hardware, software, firmware, or any combination thereof. If implemented in software, the techniques may be directed to a computer readable medium comprising program code that when executed in a device causes the device to perform one or more of the techniques described herein. In that case, the computer readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, or the like.

The program code may be stored in memory in the form of computer readable instructions. In that case, a processor, such as a DSP, may execute instructions stored in memory in order to carry out one or more of the image processing techniques. In some cases, the techniques may be executed by a DSP that invokes various hardware components to accelerate the image processing. In other cases, the units described herein may be implemented as a microprocessor, one or more application specific integrated circuits (ASICs), one or more field programmable gate arrays (FPGAs), or some other hardware-software combination.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, a hard disk, a removable disk, a compact disk read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method comprising:
receiving image data at an auto white balance (AWB) module and generating auto white balance data; and
detecting a backlight condition based on the auto white balance data.

2. The method of claim 1, wherein the image data corresponds to a captured image and wherein the auto white balance data is received by a backlight detection module, wherein the backlight detection module:
identifies a first portion of the image as an indoor region and a second portion of the image as an outdoor region;
evaluates a brightness condition by comparing elements of the indoor region to a first threshold and comparing elements of the outdoor region to a second threshold; and
detects the backlight condition in response to the evaluated brightness condition.

3. The method of claim 2, further comprising identifying a face region within the indoor region and wherein evaluating the brightness condition further comprises comparing elements of the face region with a third threshold.

4. The method of claim 2, further comprising identifying a face region within the outdoor region and wherein evaluating the brightness condition further comprises comparing elements of the face region with a third threshold.

5. The method of claim 1, further comprising applying backlight compensation based on the backlight condition.

6. The method of claim 2, wherein identifying the first portion of the image and identifying the second portion of the image comprises:
dividing the image into a plurality of substantially equal areas, wherein each of the areas comprises a number of pixels;
determining an average value of gray pixels within each of the plurality of areas; and
comparing the average value of gray pixels within each area of the plurality of areas to pre-calibrated gray pixel points corresponding to temperature zones in a color space.

7. The method of claim 6, wherein the backlight condition is detected when at least some outdoor samples of the image in a high color temperature zone include both high brightness samples and low brightness samples and wherein a number of low brightness samples in the high color temperature zone exceeds a fourth threshold.

8. The method of claim 6, wherein the backlight condition is detected when at least some outdoor samples of the image have substantially higher brightness values than at least some indoor samples of the image and wherein the number of indoor low brightness samples exceeds a fifth threshold.

9. The method of claim 6, wherein determining an average value of gray pixels within each of the plurality of areas comprises:
converting the image data from red, green and blue (RGB) image data to luma, chroma (YCbCr) image data;
summing gray pixels in each of the plurality of areas to provide a number of gray pixels in each particular area;
converting the YCbCr image data to RGB image data;
providing a sum of luminance (Y) values, a sum of chroma blue (Cb) values, and a sum of chroma red (Cr) values of the gray pixels in each particular area;
adding the summed Y values, the summed Cb values, and the summed Cr values to produce a summed YCbCr value in each particular area; and dividing the summed YCbCr value in each particular area by the number of gray pixels in each particular area.

10. An apparatus comprising:
an auto white balance (AWB) module configured to receive image data; and
a backlight detection module, wherein the backlight detection module is coupled to receive data from the AWB module and includes logic to detect a backlight condition based on an evaluation of the data from the AWB module.

11. The apparatus of claim 10, wherein the backlight detection module is configured to:
identify a first portion of the image data as an indoor region and a second portion of the image data as an outdoor region;
evaluate a brightness condition by comparing elements of the indoor region to a first threshold and comparing elements of the outdoor region to a second threshold; and
detect the backlight condition in response to the evaluated brightness condition.

12. The apparatus of claim 11, wherein the backlight detection module comprises:
an AWB interface configured to receive the data from the AWB module;
indoor/outdoor comparison logic coupled to the AWB interface and configured to identify the indoor region and to identify the outdoor region; and
backlight condition determination logic coupled to the indoor/outdoor comparison logic and configured to detect the backlight condition.

13. The apparatus of claim 10, further comprising a histogram module coupled to the backlight detection module, wherein the histogram module is configured to perform a first test on the image data, wherein when the first test passes, the backlight detection module is configured to perform a second test on the data from the AWB module, wherein when the second test passes, backlight compensation is applied.

14. The apparatus of claim 13, wherein when one of the first test and the second test fail, backlight compensation is not applied.

15. The apparatus of claim 14, further comprising a face detection module coupled to the backlight detection module, wherein the face detection module is configured to perform a third test on the image data, wherein when a face is detected, face priority backlight compensation is applied.

16. The apparatus of claim 13, wherein the first test comprises:
determining whether a number of pixels having a brightness value less than a first value exceeds a first threshold; and
determining whether a number of pixels having a brightness value greater than a second value exceeds a second threshold.

17. The apparatus of claim 13, wherein the apparatus comprises one of a wireless device, a camera, and a camcorder.

18. A computer readable medium storing computer executable code, comprising:
code executable by a computer to automatically white balance image data to generate white balance data; and
code executable by the computer to detect a backlight condition based on the white balance data.

19. The computer readable medium of claim 18, wherein the image data corresponds to a captured image, the computer readable medium further comprising:
code executable by the computer to identify a first portion of the image as an indoor region and a second portion of the image as an outdoor region;
code executable by the computer to evaluate a brightness condition by comparing elements of the indoor region to a first threshold and comparing elements of the outdoor region to a second threshold; and
code executable by the computer to detect the backlight condition in response to the evaluated brightness condition.

20. The computer readable medium of claim 18, further comprising code executable by the computer to selectively apply backlight compensation based on the backlight condition.

21. An apparatus comprising:
means for automatically white balancing image data to generate white balance data; and
means for detecting a backlight condition based on the white balance data.

22. The apparatus of claim 21, wherein the means for detecting a backlight condition further comprises means for identifying a first portion of the image as an indoor region and a second portion of the image as an outdoor region.
